(19) United States
(12) Patent Application Publication
(10) Pub. No.: US 2012/0147693 A1
(43) Pub. Date: Jun. 14, 2012

(54) ICE-SHAVING COCKTAIL SHAKER

(75) Inventors: John BAHLENHORST, Black Diamond, WA (US); Todd Larson, Black Diamond, WA (US)

(73) Assignee: SHAKER INNOVATIONS, LLC, Black Diamond, WA (US)

(21) Appl. No.: 13/316,933

(22) Filed: Dec. 12, 2011

Related U.S. Application Data
(60) Provisional application No. 61/422,311, filed on Dec. 13, 2010.

(51) Int. Cl. B01F 13/00; B02C 17/10

(52) U.S. Cl. 366/130; 241/98

(57) ABSTRACT

Ice-shaving cocktail shaker. In at least one exemplary embodiment of a cocktail shaker of the present disclosure, the cocktail shaker comprises a container sized and shaped to receive a quantity of ice and optionally a quantity of liquid, and at least one shaver insert positioned within the container, the at least one shaver insert configured to shave some or all of the quantity of ice when the ice is shaken within the container. In another embodiment, the at least one shaver insert defines at least one cutter portion configured to shave some or all of the quantity of ice when the ice is shaken within the container. In yet another embodiment, the at least one cutter portion is relatively sharp.

### PRIORITY

This application is related to, and claims the priority benefit of, U.S. Provisional Patent Application Ser. No. 61/422,311, filed Dec. 13, 2010, the contents of which are hereby incorporated into the present disclosure in their entirety.

### BACKGROUND

Cocktail shakers currently on the market allow a user to mix drinks therein and reduce the temperature of the drinks using ice or a chilled shaker vessel. However, such ice shakers cannot create mixed drinks or other beverages and also create shaved ice, which many consumers desire on the top layer of their drinks.

Accordingly, a cocktail shaker that is also capable of effectively shaving ice would be well received in the marketplace.

### BRIEF SUMMARY

In at least one exemplary embodiment of a cocktail shaker of the present disclosure, the cocktail shaker comprises a container sized and shaped to receive a quantity of ice and optionally a quantity of liquid, and at least one shaver insert positioned within the container, the at least one shaver insert configured to shave some or all of the quantity of ice when the ice is shaken within the container. In another embodiment, the at least one shaver insert defines at least one cutter portion configured to shave some or all of the quantity of ice when the ice is shaken within the container. In yet another embodiment, the at least one cutter portion is relatively sharp.

In at least one exemplary embodiment of a cocktail shaker of the present disclosure, the at least one shaver insert defines at least one shaver aperture therethrough, the at least one shaver aperture sized and shaped to shave some or all of the quantity of ice when the ice is shaken within the container. In an additional embodiment, the at least one shaver insert defines at least one shaver aperture therethrough at or near the at least one cutter portion, the at least one shaver aperture sized and shaped so that shaved ice can pass therethrough. In yet an additional embodiment, the at least one shaver insert has a configuration selected from the group consisting of a partially cylindrical configuration, a fully cylindrical configuration, and a straight configuration.

In at least one exemplary embodiment of a cocktail shaker of the present disclosure, the at least one shaver insert further comprises one or more flanges. In another embodiment, the at least one shaver insert has at least one rounded edge. In yet another embodiment, the at least one shaver insert is comprised of stainless steel.

In at least one exemplary embodiment of a cocktail shaker of the present disclosure, the cocktail shaker further comprises a dome having a lower portion configured to sealably engage an upper portion of the container. In an additional embodiment, the dome defines one or more apertures therethrough. In yet an additional embodiment, the one or more apertures are sized and shaped to permit shaved ice to pass therethrough.

In at least one exemplary embodiment of a cocktail shaker of the present disclosure, the cocktail shaker further comprises a cap configured to sealably engage an upper portion of the dome. In another embodiment, the container, the shaver insert, the dome, and the cap are comprised of stainless steel. In yet another embodiment, the container, the shaver insert, the dome, and the cap are comprised of one or more materials selected from the group consisting of metal, glass, and plastic.

In at least one exemplary embodiment of a cocktail shaker of the present disclosure, the at least one cutter portion comprises one or more teeth. In an additional embodiment, the at least one cutter portion is coupled to at least one extension arm, the at least one extension arm coupled to the container to retain the at least one cutter portion within the container. In yet an additional embodiment, the at least one shaver insert is coupled to at least part of the container.

In at least one exemplary embodiment of a cocktail shaker of the present disclosure, the cocktail shaker comprises a container having an upper portion and an inner portion, the container sized and shaped to receive a quantity of ice and optionally a quantity of liquid, a dome having an upper portion and a lower portion, the lower portion of the dome configured to sealably engage an upper portion of the container, the dome defining one or more apertures defined therethrough, a cap configured to sealably engage the upper portion of the dome, and at least one shaver insert positioned within the container, the at least one shaver insert defining at least one cutter portion and configured to shave some or all of the quantity of ice when the ice is shaken within the container.

In at least one exemplary embodiment of a shaver insert of the present disclosure, the shaver insert defines at least one cutter portion and is configured to fit within a mixing container, the shaver insert capable of shaving some or all of a quantity of ice when the ice is shaken within the mixing container containing the shaver insert.

### BRIEF DESCRIPTION OF THE DRAWINGS

FIG. 1 shows a partially exploded view of various components of an exemplary cocktail shaker according to an embodiment of the present disclosure;

FIG. 2A shows a front perspective view of an exemplary shaver insert according to an embodiment of the present disclosure;

FIG. 2B shows a top view of the exemplary shaver insert shown in FIG. 2A;

FIG. 2C shows a front view of an exemplary shaver insert according to an embodiment of the present disclosure;

FIG. 2D shows a front view of a portion of an exemplary shaver insert according to an embodiment of the present disclosure;

FIG. 2E shows a front view of a portion of an exemplary shaver insert according to an embodiment of the present disclosure; and

FIG. 3 shows an exploded view of various components of an exemplary cocktail shaker according to an embodiment of the present disclosure.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

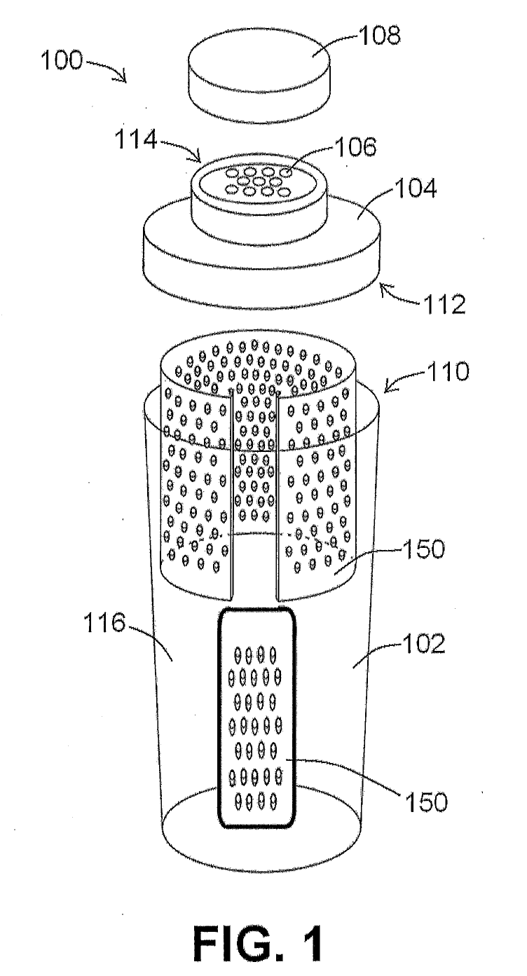

An exemplary embodiment of a cocktail shaker of the present disclosure is shown in FIG. 1. As shown in FIG. 1, cocktail shaker 100 comprises a container 102, a dome 104 defining one or more strainer apertures 106, and a cap 108. In various embodiments of cocktail shakers 100 of the present disclosure, container 102, dome 104, and cap 108 are configured so that an upper portion 110 of container 102 can engage a lower portion 112 of dome 104, and so that an upper portion 114 of dome 104 can engage cap 108. In such embodiments, and when one or more liquids (alcohol, drink mixes, soda, fruit juice, water, etc.) and/or ice are placed within container 102, said contents of container 102 will not leak from cocktail shaker 100 when container 102, dome 104, and cap 108 securely engage one another, allowing a user of cocktail shaker 100 to shake the contents therein.

Cocktail shakers 100 of the present disclosure further comprise at least one shaver insert. In at least one embodiment, and as shown in FIG. 1, cocktail shavers 100 of the present disclosure may comprise one, two, or more shaver inserts 150 that are either unsecured within container 102, removably coupled to an inner portion 116 of container 102, or fixedly coupled to an inner portion 116 of container 102. In various other embodiments, one, two, or more shaver inserts 150 may be placed in and/or coupled to one or more of dome 104 and/or cap 108 in addition to or in lieu of placement of shaver inserts 150 within container 102.

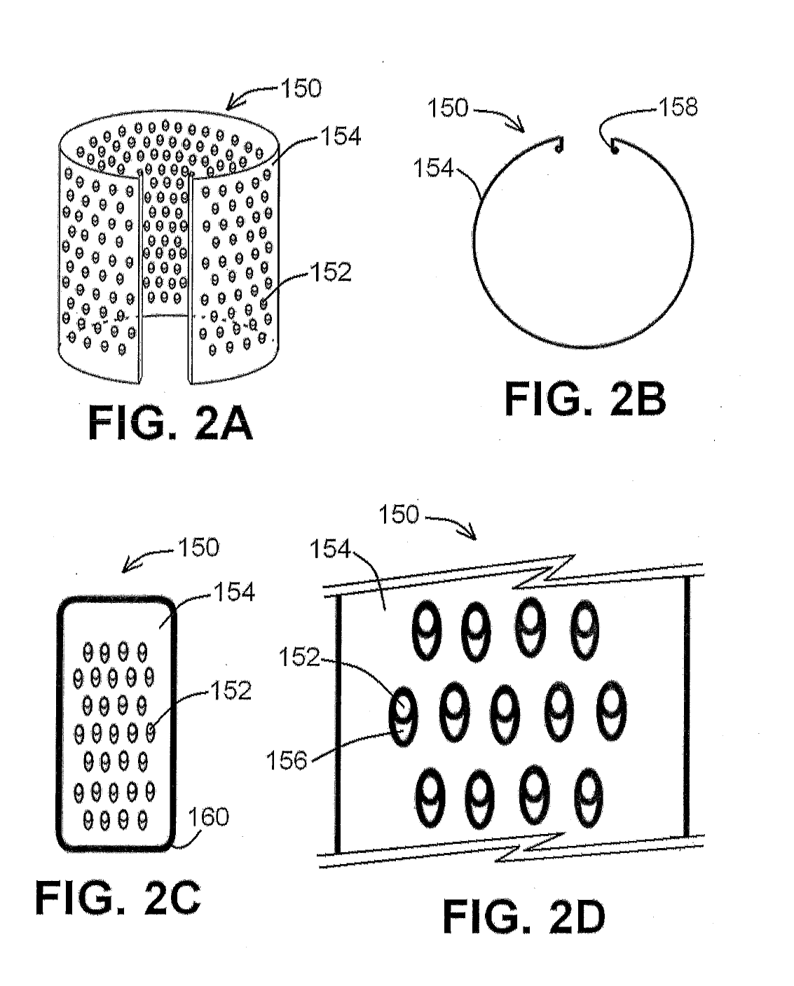

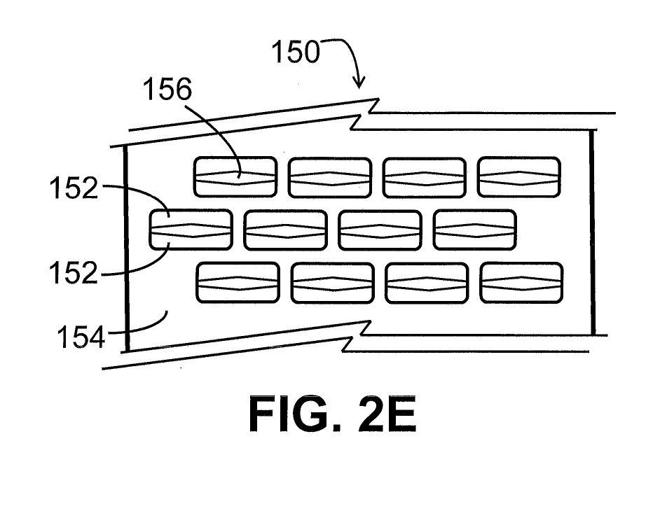

Shaver inserts 150, shown within cocktail shaker 100 in FIG. 1 and shown outside of cocktail shaker 100 in FIGS. 2A, 2B, 2C, and 2D, may comprise any number of configurations suitable for use with various embodiments of cocktail shakers 100 of the present disclosure. In various embodiments, and as shown in FIGS. 2A and 2C, shaver inserts 150 define one or more shaver apertures 152 through insert wall(s) 154. Shaver apertures 152, as shown in FIGS. 2A and 2C, may be defined within shaver inserts 150 as an opening through shaver insert 150 itself, and as shown in the enlarged view of at least a portion of an exemplary shaver insert 150 shown in FIGS. 2D and 2E, may include and/or define a cutter portion 156 configured so that when a quantity of ice is placed within an exemplary cocktail shaker 100 having one or more shaver inserts 150 therein, closure of cocktail shaker 100 (using dome 104 and cap 108, for example) and shaking the contents thereof would cause some or all of the ice therein to be shaved within cocktail shaker 100. Cutter portions 156, in various embodiments, may be relatively sharp so to effectively shave ice as ice comes into contact with cutter portion(s) 156. As shown in FIGS. 2D and 2E, cutter portion 156 may be defined in connection with the defining of one or more a corresponding shaver apertures 152, as the creation of shaver apertures 152 may also involve bending a portion of wall 154 to create cutter portion 156.

In various exemplary embodiments of cocktail shakers 100 of the present disclosure, shaver insert 150 defines one or more shaver apertures 152 therethrough, wherein shaver apertures 152 are sized and shaped to engage at least a portion of an ice cube, for example, and cause at least part of the ice cube to shave away from the remainder of the ice cube. In other embodiments, shaver inserts 150 may not have any shaver apertures 152 defined therethrough, instead having one or more cutter portions 156 capable of shaving ice as referenced herein.

Shaver inserts 150 of the present disclosure may comprise any number of configurations. For example, and as shown in FIGS. 2A and 2B, shaver inserts 150 may be fully or partially cylindrical, and cutter portion(s) 156 included and/or defined therein may face inward as when such an embodiment is used within a container 102, the ice would be on the relative inside of said shaver insert. For ease of inserting and/or removing such an embodiment of a shaver insert 150, said embodiment, or other embodiments of shaver inserts 150 of the present disclosure, may comprise one or more flanges 158 to provide a user of a cocktail shaker 100 with an effective grip portion.

Other shaver inserts 150 of the present disclosure may also be relatively straight or flat, such as the embodiment shown in FIG. 2C. Such an embodiment, as well as other embodiments, may comprise one or more rounded edges 160 as shown in FIG. 2C, so that a user of a cocktail shaker 100 of the present disclosure can avoid potential injury when inserting or removing a shaver insert 150 that would otherwise have one or more relatively sharp corners.

In at least one embodiment, the aperture(s) 106 defined within dome 104 are sized and shaped so that shaved ice within container 102 can fit therethrough when, for example, container 102 is inverted so that the liquid and/or shaved ice contents can exit container through aperture(s) 106 of dome 104 when dome 104 is coupled to container 102. Desired results, such as the inclusion of finely grated ice shavings and crystals within a mixed drink, for example, can therefore be achieved with the same or a similar amount of shaking as is typical when creating the standard cocktail. The amount of ice shavings can be increased or reduced by adding or removing one or more shaver inserts 150 or by increasing or decreasing the duration and/or vigor of shaking. Furthermore, the overall size and flexibility of the design of various shaver inserts will allow for insertion into any number of cocktail shakers currently on the market.

Various components of cocktail shakers 100 of the present disclosure can comprise any number of suitable materials. For example, and in at least one embodiment, the one or more shaver inserts 150 may be comprised of stainless steel, and one or more other components of cocktail shaker 100 may also comprise stainless steel. In at least another embodiment, plastic glass, and/or other metals may be used for one or more cocktail shaker 100 components.

The various embodiments of shaver inserts 150 of the present disclosure may also be provided outside of an overall cocktail shaker 100. For example, and in at least one embodiment of a shaver insert 150 of the present disclosure, shaver insert 150 may be sold as a separate component, and a purchaser may use shaver insert 150 in connection with a traditional cocktail shaker, for example, to create shaved ice as described herein.

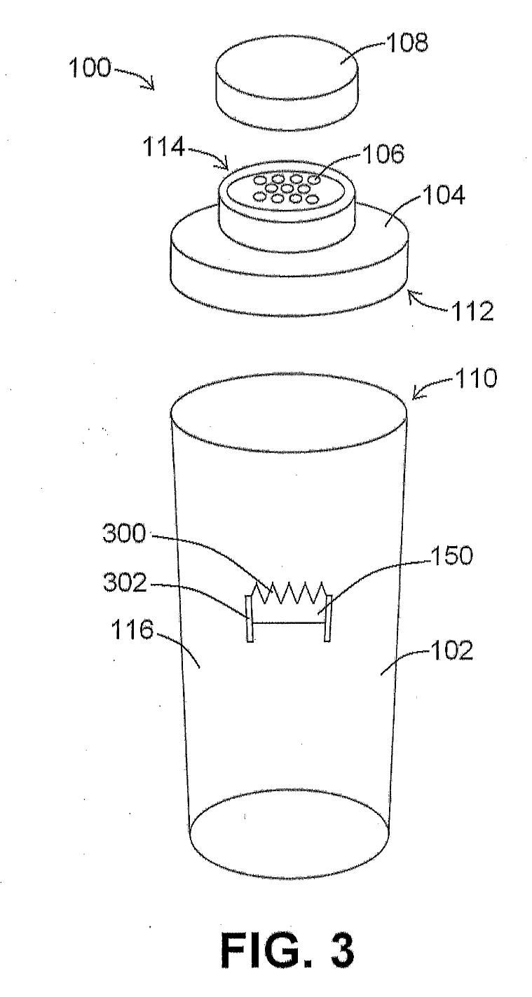

An additional exemplary embodiment of a cocktail shaker 100 of the present disclosure is shown in FIG. 3. As shown in FIG. 3, cocktail shaker 100 comprises a shaver insert 150 defining a cutter portion 156 having one or more teeth 300, whereby teeth 300 are capable of shaving ice when ice is placed within cocktail shaker 100 and shaken. Cutter portion 156, as shown in FIG. 3, may extend from a wall of container 100 by way of one or more extension arms 302.

Various embodiment of cocktail shakers 100 of the present disclosure, as generally referenced herein, are useful to make mixed drinks with shaved ice. For example, a martini could be made using an exemplary cocktail shaker 100 of the present disclosure, whereby a user would place quantities of gin (or vodka), vermouth, and ice into cocktail shaker 100, and after shaking those contents, the contents, which would comprise a mixed drink (a martini) and shaved ice, could be strained through dome 104 into a suitable vessel, such as a martini glass, for example, resulting in a martini with an upper portion of shaved ice. Any number of other alcoholic or non-alcoholic drinks could also be made with shaved ice using any number of embodiments of the present disclosure.

While various embodiments of ice-shaving cocktail shakers and methods for using the same have been described in considerable detail herein, the embodiments are merely offered by way of non-limiting examples of the disclosure described herein. It will therefore be understood that various changes and modifications may be made, and equivalents may be substituted for elements thereof, without departing from the scope of the disclosure. Indeed, this disclosure is not intended to be exhaustive or to limit the scope of the disclosure.

Further, in describing representative embodiments, the disclosure may have presented a method and/or process as a particular sequence of steps. However, to the extent that the method or process does not rely on the particular order of steps set forth herein, the method or process should not be limited to the particular sequence of steps described. Other sequences of steps may be possible. Therefore, the particular order of the steps disclosed herein should not be construed as limitations of the present disclosure. In addition, disclosure directed to a method and/or process should not be limited to the performance of their steps in the order written. Such sequences may be varied and still remain within the scope of the present disclosure.

We claim:

1. A cocktail shaker comprising:
a container sized and shaped to receive a quantity of ice and optionally a quantity of at least one liquid; and
at least one shaver insert positioned within the container, the at least one shaver insert configured to shave some or all of the quantity of ice when the ice is shaken within the container.

2. The cocktail shaker of claim 1, wherein the at least one shaver insert defines at least one cutter portion configured to shave some or all of the quantity of ice when the ice is shaken within the container.

3. The cocktail shaker of claim 2, wherein the at least one shaver insert defines at least one shaver aperture therethrough at or near the at least one cutter portion, the at least one shaver aperture sized and shaped so that shaved ice can pass therethrough.

4. The cocktail shaker of claim 2, wherein the at least one cutter portion comprises one or more teeth.

5. The cocktail shaker of claim 4, wherein the at least one cutter portion is coupled to at least one extension arm, the at least one extension arm coupled to the container to retain the at least one cutter portion within the container.

6. The cocktail shaker of claim 1, wherein the at least one shaver insert is removable from the container.

7. The cocktail shaker of claim 1, wherein the at least one shaver insert defines at least one shaver aperture therethrough, the at least one shaver aperture sized and shaped to shave some or all of the quantity of ice when the ice is shaken within the container.

8. The cocktail shaker of claim 1, wherein the at least one shaver insert has a configuration selected from the group consisting of a partially cylindrical configuration, a fully cylindrical configuration, and a straight configuration.

9. The cocktail shaker of claim 1, wherein the at least one shaver insert is partially cylindrical.

10. The cocktail shaker of claim 1, wherein the at least one shaver insert has at least one rounded edge.

11. The cocktail shaker of claim 1, wherein the at least one shaver insert is comprised of stainless steel.

12. The cocktail shaker of claim 1, further comprising:
a dome having a lower portion configured to sealably engage an upper portion of the container.

13. The cocktail shaker of claim 12, wherein the dome defines one or more apertures therethrough.

14. The cocktail shaker of claim 13, wherein the one or more apertures are sized and shaped to permit shaved ice to pass therethrough.

15. The cocktail shaker of claim 12, further comprising:
a cap configured to sealably engage an upper portion of the dome.

16. The cocktail shaker of claim 15, wherein the container, the at least one shaver insert, the dome, and the cap are comprised of stainless steel.

17. The cocktail shaker of claim 15, wherein the container, the at least one shaver insert, the dome, and the cap are comprised of one or more materials selected from the group consisting of metal, glass, and plastic.

18. The cocktail shaker of claim 1, wherein the at least one shaver insert is coupled to at least part of the container.

19. A cocktail shaker comprising;
a container having an upper portion and an inner portion, the container sized and shaped to receive a quantity of ice and optionally a quantity of at least one liquid;
a dome having an upper portion and a lower portion, the lower portion of the dome configured to sealably engage an upper portion of the container, the dome defining one or more apertures defined therethrough;
a cap configured to sealably engage the upper portion of the dome; and
at least one shaver insert positioned within the container, the at least one shaver insert defining at least one cutter portion and configured to shave some or all of the quantity of ice when the ice is shaken within the container.

20. A method of mixing a drink comprising the steps of
providing a cocktail shaker comprising:
a container having an upper portion and an inner portion, the container sized and shaped to receive a quantity of ice and optionally a quantity of at least one liquid;
a dome having an upper portion and a lower portion, the lower portion of the dome configured to sealably engage an upper portion of the container, the dome defining one or more apertures defined therethrough;
a cap configured to sealably engage the upper portion of the dome; and
at least one shaver insert positioned within the container, the at least one shaver insert defining at least one cutter portion and configured to shave some or all of the quantity of ice when the ice is shaken within the container;
adding a quantity of ice to the container;
adding a quantity of at least one liquid to the container;
sealably engaging the lower portion of the dome to the upper portion of the container;
sealably engaging the cap to the upper portion of the dome;
shaking the cocktail shaker, thereby shaving all or some of the ice contained therein as the ice comes into contact with the at least one cutter portion of the at least one shaver insert;
removing the cap from the cocktail shaker; and
inverting the cocktail shaker over a vessel, wherein the at least one liquid and shaved ice exit the container through the one or more apertures of the dome into the vessel.
